(19) United States
(12) Patent Application Publication
(10) Pub. No.: US 2008/0130629 A1
(43) Pub. Date: Jun. 5, 2008

(54) Attached internet telephone device

(75) Inventor: Huan-Chang Yang, Sanchong City (TW)

Correspondence Address: BIRCH STEWART KOLASCH & BIRCH, PO BOX 747, FALLS CHURCH, VA, 22040-0747, US

(73) Assignee: DYNAMIC SYSTEM ELECTRONICS CORP.

(21) Appl. No.: 11/607,043

(22) Filed: Dec. 1, 2006

(51) Int. Cl. H04L 12/66

(52) U.S. Cl. 370/352

(57) ABSTRACT

An attached internet telephone device is disclosed herein, which is capable of adding an internet telephone function to a host having internet connection capacity but lacking an internet telephone function. The attached internet telephone device comprises a USB module, a memory module, a communication module, and a controller. The controller retrieves an internet telephone software program from the memory unit after a USB interface of the USB module is plugged into a USB interface of the host, and installs the software program to the host. After the installation is completed, under the control of the communication module, a user may perform internet telephone communication with the host that lacks the internet telephone function originally.

### BACKGROUND OF THE INVENTION

1. Field of the Invention

The present invention relates to an internet telephone device, and in particular to an internet telephone device that adds an internet telephone function to a host lacking the function thereof.

2. The Prior Arts

With the advancement of internet telephone technology, such as Skype, the VoIP communication quality has caught up with the communication quality of conventional telephones, which attracts more and more people to turn to VoIP in respect of voice communication. However, VoIP operates mainly on personal computers, which constitutes obstacles in the popularization of VoIP. To solve this problem, many manufacturers come up with communication devices that support VoIP.

Most VoIP communication devices carry a USB interface for plugging into a USB interface of a personal computer. After the driver program of the corresponding communication device is installed, a user needs to install an internet telephone software program, such as Skype. When a phone call from other Skype user comes in, a ringing module included in the VoIP communication device makes sounds to inform the user of an incoming call. After the user pushes the talk button, he/she may communicate with the caller as he/she does over a conventional telephone.

A VoIP communication device is capable of installing the driver software automatically through the PnP function of the USB interface, and enables the communication device hardware to function. However, the VoIP communication device also requires the support of a corresponding software program to achieve internet phone communication. The installation of the corresponding software program to a personal computer constitutes an obstacle for people not familiar with personal computers.

On the other hand, though internet telephone devices capable of operating independently without linkage to a personal computer are available, they are expensive because they have to include components for TCP/IP communication. Therefore, it is desirable to bring to the market an internet telephone device that takes advantage of the TCP/IP communication function of personal computers, as well as helps the user complete the installation of the corresponding software program.

### SUMMARY OF THE INVENTION

A primary objective of the present invention is to provide an attached internet telephone device, which, under the control of a controller, installs a built-in internet telephone software program to a host, such as a personal computer, lacking internet telephone function, and enables a user to perform internet telephone communication with his communication device under the control of a communication module.

To implement the aforementioned objective, the attached internet telephone device according to the present invention comprises mainly a USB module, a memory module, a communication module, and a controller. The USB module includes a USB interface, and communicates with the host through the USB interface after the USB interface is plugged into a USB interface of the host. The memory module includes a memory unit, which has a storage capacity of an internet telephone software program at least. The communication module transmits through the USB module the voice signal coming from the communication device to the host, and transmits through the USB module the voice signal coming from the host to the communication device. The controller retrieves an internet telephone software program from the memory unit after the USB interface is plugged into the USB interface of the host, installs the software program to the host, and afterwards enables the user to perform internet telephone communication with a communication device under the control of the communication module.

### BRIEF DESCRIPTION OF THE DRAWINGS

The present invention will be apparent to those skilled in the art by reading the following detailed description of preferred embodiments thereof with reference to the attached drawings, in which:

FIG. 1 is a schematic view of an internet telephone device in accordance with a first preferred embodiment of the present invention; and

FIG. 2 is a schematic view of an internet telephone device in accordance with a second preferred embodiment of the present invention.

### DETAILED DESCRIPTION OF THE PREFERRED EMBODIMENT

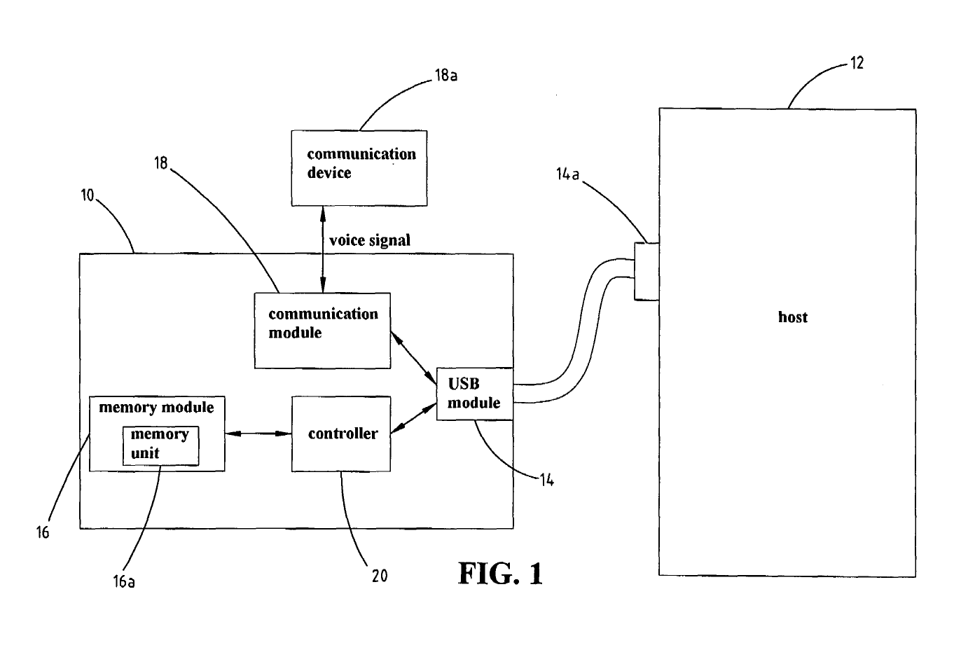

With reference to FIG. 1, an attached internet telephone device 10 according to the present invention comprises at least a USB module 14 with a USB interface 14a, a memory module 16 with a memory unit 16a, a communication module 18, and a controller 20. If the receiving component and transmitting component of the communication device 18a is an earphone and a microphone respectively or a headset, a terminal jack will be disposed on the attached internet telephone device 10 so that the communication device 18a can be plugged in and receive the control of the communication module 18. If the attached internet phone device 10 comes in the form of a mobile phone or a handset, the receiving component and transmitting component are equivalent to those of a mobile phone or a handset.

The attached internet telephone device 10 is to add the internet telephone function to a host 12, such as a personal computer, with internet connection capability but lacking internet telephone function. In short, after the USB interface 14a is plugged into the USB interface (not shown) of the host 12, the driver program is automatically installed as with an ordinary USB device. Then the controller 20 retrieves the internet telephone software program from the memory unit 16a, transmits the software program to the host 12 through the USB module 14, and completes the installation to the host 12 after the confirmation of a user. After the aforementioned installation is completed, the user may perform internet telephone communication under the control of the communication module 18 by means of the communication device 18a.

If a number of internet telephone software programs with internet telephone communication capability, such as Skype, MSN messenger, and Yahoo messenger, are stored in the memory unit 16a of the memory module 16, the controller 20 will display a selection interface on a display device (not shown) of the host 12 or a built-in display device of the attached internet telephone device 10 for requesting the user to select a desired internet telephone software program, and then install as requested.

How the internet telephone software program performs internet telephone communication through the host 12 which has internet connection capability belongs to the scope of the prior art. Below a simple description of the communication process will be provided as an illustration.

When a user tries to make an internet phone call by means of the attached internet telephone device 10 in accordance with the present invention, after the connection is established, the communication module 18, which has speech coding and processing capability, transmits the voice signal coming from the communication device 18a to the host 12 through the USB module 14 and USB interface 14a, and then the voice is transmitted by the host 12 to the other party. When the other party makes a response, the voice signal is transmitted through the host 12 to the USB module 14 by way of the USB interface 14a and cables, and then transmitted by the communication module 18 to the communication device 18a.

To prevent the telephone device from being dialed without permission, a verification function is further included in the attached internet telephone device 10. A login account and a password will be recorded for the convenience of the user when making phone calls.

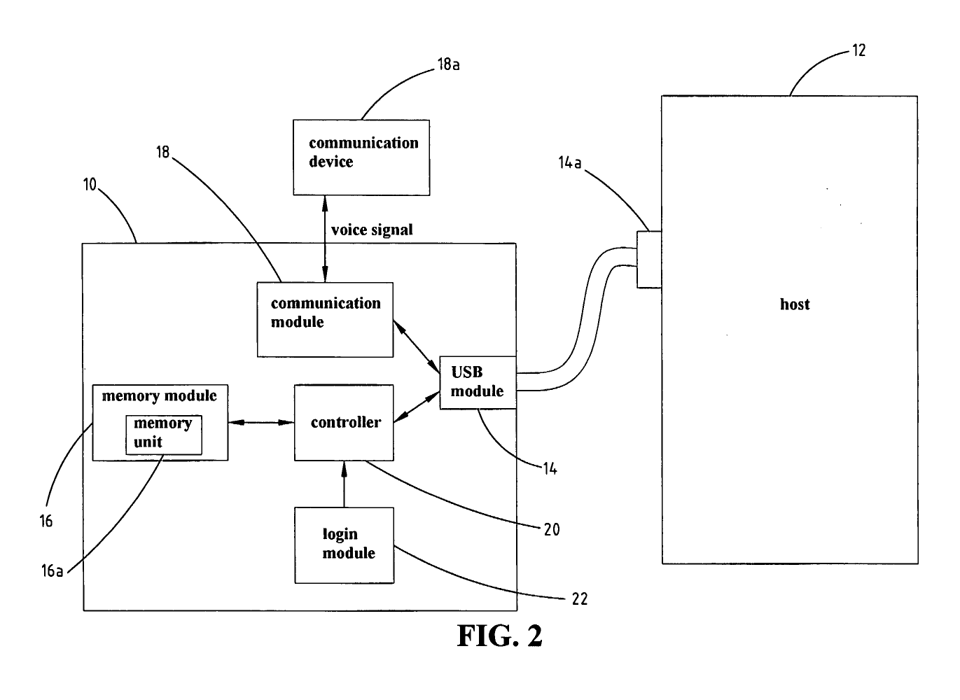

With reference to FIG. 2, which is a schematic view of an attached internet telephone device 10 in accordance with a second preferred embodiment of the present invention, besides a USB module 14 with a USB interface 14a, a memory module 16 with a memory unit 16a, a communication module 18, and a controller 20, the internet telephone device 10 further includes a login module 22.

The login module 22 displays a login interface on a display device (not shown) of the host 12 or a built-in display device of the attached internet telephone device 10 for requesting the user to input verification information, such as login account and password at least, and permits the execution of the attached internet telephone device 10 only after the verification is successful. The account and password may be created specifically for the attached internet telephone device 10 or identical to those for executing the internet telephone software program. If the latter is the case, the account and password may be recorded in the memory unit 16a of the memory module 16 when the user logs in the internet telephone software program successfully, so that the login module 22 may perform automatic login afterwards according to the account and password stored in the memory unit 16a.

Furthermore, if the internet telephone software program further includes a recording function, as the USB module is capable of transmitting data to and from the host 12 through the USB interface 14a, the recorded voice file may be transmitted through the USB interface 14a and be stored in the memory unit 16a by the memory module 16. The controller 20 may execute data storage to and retrieval from the memory unit 16a of the memory module 16 according to a storage/retrieval command from the host 12. In this way, the attached internet telephone device 10 is equipped with data storage/retrieval capability of a flash drive.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An attached internet telephone device which makes a host having internet connection capability equip with an internet telephone function, comprising:
a USB module which includes a USB interface, and is capable of transmitting data to and from the host through the USB interface after the USB interface is plugged into a USB interface of the host;
a memory module which includes a memory unit, and is capable of storing at least an internet telephone software program;
a communication module which transmits a voice signal from a communication device through the USB module, and transmits a voice signal from the host to the communication device through the USB module; and
a controller which, after the USB interface is plugged into the USB interface of the host, retrieves the internet telephone software program from the memory unit, installs the internet telephone software program to the host, and enables a user to perform internet telephone communication with the communication device under the control of the communication module.

2. The attached internet telephone device as claimed in claim 1, further comprising a login module, which requests a user to input at least an account and a password through a login interface, and permits the execution of the attached internet telephone device only after the verification is successful.

3. The attached internet telephone device as claimed in claim 2, wherein after the verification is successful, the account and the password are recorded in the memory unit of the memory module, so that the login module is capable of performing automatic login according to the account and the password recorded in the memory unit.

4. The attached internet telephone device as claimed in claim 1, wherein the internet telephone software program further includes a recording function and stores the recorded voice file in the memory unit of the memory module by means of the memory module.

5. The attached internet telephone device as claimed in claim 1, wherein the controller performs data storage to and retrieval from the memory unit of the memory module by means of the memory module according to a storage/retrieval command from the host.

6. The attached internet telephone device as claimed in claim 1, wherein when a plurality of internet telephone software programs are stored in the memory unit of the memory module, the controller is capable of requesting the user to select an internet telephone software program for installation through a selection interface.
